(19) United States
(12) Patent Application Publication
(10) Pub. No.: US 2002/0003164 A1
(43) Pub. Date: Jan. 10, 2002

(54) Information retrieval method for an IC card and portable information terminal device

(75) Inventors: Yuko Nakagawa, Tokyo (JP); Takeshi Otsuka, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/901,061

(22) Filed: Jul. 10, 2001

(30) Foreign Application Priority Data
Jul. 10, 2000 (JP) 207767/2000

(51) Int. Cl. G06K 5/00

(52) U.S. Cl. 235/380

(57) ABSTRACT

Provided to a portable information terminal device (portable telephone set) (20), an information reading sensor (25) reads information stored in a chip memory (112) of an IC card (10) through an antenna coil (12) to store read information in a terminal memory (22) via a terminal CPU (21). Accordingly, by holding the IC card (10) with the information reading sensor (25), the information reading sensor (25) can read directory information. Responsive to operation of a keyboard (23), the terminal CPU (21) retrieves the stored information in the terminal memory (22) to obtain only desired information. In addition, the terminal CPU (21) displays retrieved information on a display portion (24).

### BACKGROUND OF THE INVENTION

This invention relates to a method of retrieving an information stored in an integrated circuit (IC) card and a portable information terminal device.

In the manner known in the art, the integrated circuit (IC) card is a card in which an IC chip is embedded such that a large quantity of information can be stored in the IC card as compared to a magnetic card. Therefore, in the near future, it is expected that the IC card spreads widely and be popularly used such that the card contains various kinds of information.

IC cards are classified into contact IC cards (IC cards with external terminals) and non-contact IC cards. The non-contact IC card can read/write data therein/therefrom by the use of an electromagnetic wave.

The “non-contact IC card” is an IC card where data can be read/written therefrom/therein by a reader/writer without directly brought into contact with the reader/writer. The reader/writer radiates an electromagnetic wave (an alternating current). A coil antenna is embedded in the non-contact IC card. The electromagnetic wave makes the coil antenna generate an electromotive force in accordance with a principle of electromagnetic induction. The electromotive force renders the IC chip mounted on the IC card to operate.

Recently the non-contact IC card has become familiar to us. For example, Nippon Telegraph and Telephone Company set up the public telephones those matches with the non-contact IC cards since March, 1999. East Japan Railway Company anticipates to employ the IC cards as tickets since 2001. In addition, uses for the non-contact IC cards are not restricted to the public telephones and the tickets for railways. For instance, Electronic Toll Collection system in toll roads is now being practically used in a part of the toll roads at present.

Although we want to know the kind and the contents of information stored in our own IC cards in some cases, it is actually impossible (or difficult) to remember all the information stored therein. Accordingly, it is very convenient if we can simply retrieve information stored in the our own IC cards ourselves by means of some methods (means).

However, the data stored in the IC card of the type described may only be written, erased, renewed, etc. only when the IC card is inserted in an IC card exclusive reader/writer (which will be called an “IC card reader/writer” hereinafter) connected to an information processing terminal such as a personal computer. Accordingly, in order to perform input/output of various data to/from the IC card and to check the contents stored in the IC card, an owner of the IC card always must go to a place where the IC card reader/writer is set, which makes the use very troublesome. In addition, although the IC card owner has the information processing terminal such as the personal computer which is connectable to a network, for example, the Internet, a business transaction using the network cannot be carried out if the IC card reader/writer is not connected to the personal computer. This is also inconvenient.

In order to solve the above-mentioned inconveniences, a communication terminal (e.g. a portable telephone set or the like) in which a data carrier (e.g. an IC card or the like) is incorporated is proposed in, for example, Japanese Unexamined Patent Publication (JP-A) No. H. 11-213,111 or JP-A 11-213111. According to JP-A 11-213111, the portable telephone set (the communication terminal) comprises means for carrying out a telephone call and data communication with an external communication equipment (e.g. a telephone set or a host computer). In addition, the portable telephone set (the communication terminal) further comprises display means for displaying data from the external communication equipment or data where the IC card (data carrier) incorporated in the portable telephone set carries.

According to the portable telephone set with such structure, an owner of the data carrier and the portable telephone set can refer to and check data given from the external communication equipment or data carried by the data carrier by the use of the display means. In addition, data can be transmitted/received between the data carrier and a host computer installed in the banks or the like through the portable telephone set. With this structure, it is possible to perform the so-called electronic commerce or the like because the data can be transmitted/received between the data carrier and the information processing terminal connected to the network such as the Internet.

As described above, JP-A 11-213111 discloses the way to display the contents of various data in the IC card on a display part using the portable telephone set (the communication terminal). However, JP-A 11-213111 merely discloses a way to display data in the IC card on the display part of the portable telephone set and neither discloses nor teaches the way to retrieve only the necessary data.

### SUMMARY OF THE INVENTION

It is an object of this invention to provide an information retrieval method and device for an IC card, in which an owner of the IC card can simply retrieve information stored in the IC card.

Other objects of this invention will become clear as the description proceeds.

According to a first aspect of this invention, a method is for retrieving information stored in an integrated circuit (IC) card. The method comprises the steps of reading the information in the IC card by using an information reading sensor mounted in a portable information terminal device including input means, display means, and memory means to store read information in the memory means as stored information, of retrieving, in response to operation of the input means of the portable information terminal device, the stored information in the memory means to obtain only desired information as retrieved information, and of displaying the retrieved information on the display means of the portable information terminal device.

According to a second aspect of this invention, a method is for retrieving information stored in an integrated circuit (IC) card. The method comprises the steps of reading the information in the IC card by using a reader mounted in a portable information terminal device including input means, display means, and memory means to store read information in the memory means as stored information, of retrieving, in response to operation of the input means of the portable information terminal device, the stored information in the memory means to obtain only desired information as retrieved information, and of displaying the retrieved information on the display means of the portable information terminal device.

According to a third aspect of this invention, a portable information terminal device comprises input means, display means, and memory means. The portable information terminal device further comprises an information reading sensor for reading information stored in an integrated circuit (IC) card to store read information in the memory means as stored information, a retrieving arrangement, in response to operation of the input means, retrieving the stored information in the memory means to obtain only desired information as retrieved information, and a displaying arrangement for displaying the retrieved information on the display means.

According to a fourth aspect of this invention, a portable information terminal device comprises input means, display means, and memory means. The portable information terminal device further comprises a reader for reading information stored in an integrated circuit (IC) card to store read information in the memory means as stored information, a retrieving arrangement, in response to operation of the input means, retrieving the stored information in the memory means to obtain only desired information as retrieved information, and a displaying arrangement for displaying the retrieved information on the display means.

### BRIEF DESCRIPTION OF THE DRAWING

FIG. 1 shows a block diagram of a portable information terminal device together with an IC card which realizes an information retrieval method for the IC card according to a first embodiment of this invention;

FIG. 2 is a flow chart for use in describing operation of the information retrieval method for the IC card in the portable information terminal device illustrated in FIG. 1; and

FIG. 3 shows a block diagram of a portable information terminal device, together with an IC card, which realizes an information retrieval method for the IC card according to a second embodiment of this invention.

### DESCRIPTION OF THE PREFERRED EMBODIMENTS

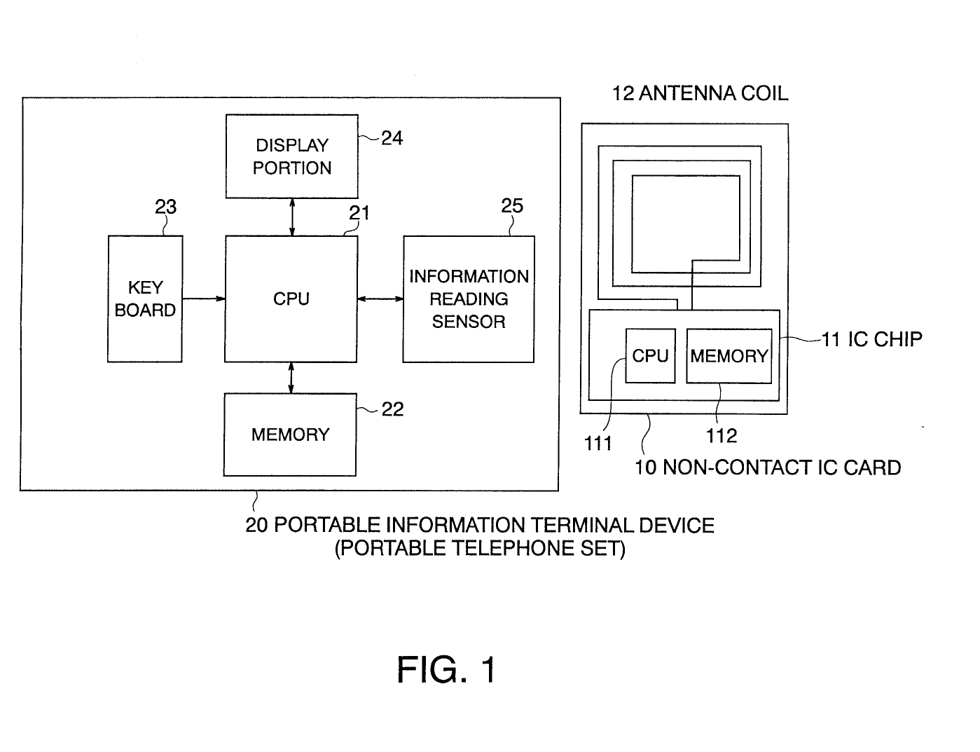

Referring to FIG. 1, the description will proceed to a portable information terminal device 20 to realize an information retrieval method for an IC card 10 according to a first embodiment of this invention.

The illustrated IC card 10 is a non-contact IC card and is provided with an IC chip 11 and an antenna coil 12. The IC chip 11 contains a chip microcomputer (CPU) 111, a chip memory 112, and so on. The antenna coil 12 is for carrying out transmission/reception of data with to/from outside in a non-contact fashion. The IC chip 11 registers directory information indicative of a list of information stored in the IC card 10.

On the other hand, the illustrated portable information terminal device 20 is a portable telephone set and comprises a terminal microcomputer (CPU) 21, a terminal memory 22, a keyboard (an input portion) 23, a display portion 24, and an information reading sensor 25. The information reading sensor 25 is embedded in the portable information terminal device 20. The information reading sensor 25 reads, through the antenna coil 12, the information stored in the chip memory 112 of the IC card 10 to store read information to the terminal memory 22 as stored information. Accordingly, the information reading sensor 25 can read the directory information by holding the IC card 10 to the information reading sensor 25. Responsive to a key operation in the keyboard 23, the terminal CPU 21 retrieves the information stored in the terminal memory 22 to obtain only desired information as retrieved information in the manner which will later become clear. In addition, the terminal CPU 21 displays the retrieved information on the display portion 24.

With this structure, it is possible to refer to/retrieve information registered (stored) in the IC card 10 owned by him-/herself whenever needed.

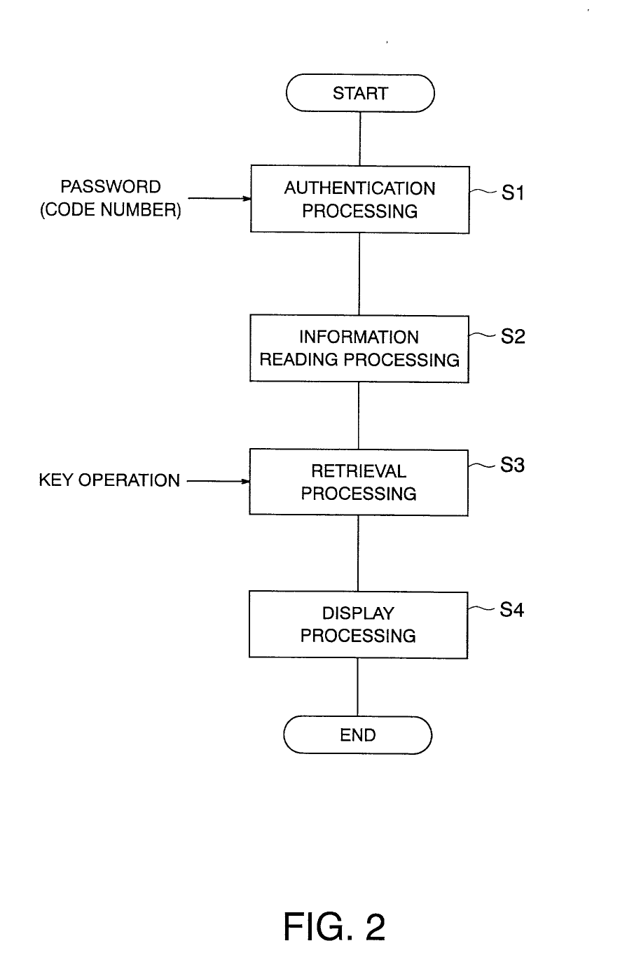

Referring now to FIG. 2 in addition to FIG. 1, the description will proceed to the information retrieval method for the IC card 10 using the portable information terminal device 20 according to this invention.

When an owner of the IC card 10 does not know what kind of information is stored in the own IC card 10, information retrieval is carried out. As for an example of the situation, the IC card owner wants to know the expiration date of the validity term of his commuter pass.

First, the IC card 10 is held up to the information reading sensor 25. In this state, the terminal CPU 21 carries out authentication processing at a step S1. More specifically, the owner of the IC card 10 inputs an owner's password or an owner's code number into the terminal CPU 21 by operating keys of the keyboard 23. The terminal CPU 21 activates the information reading sensor 25 to read a card's password or a card's code number of the IC card 10 from the chip memory 112 of the IC card 10. Subsequently, the terminal CPU 21 compares the owner's password (owner's code number) inputted from the keyboard 23 with the card's password (card's code number) read from the information reading sensor 25. If the owner's password (owner's code number) coincides with the card's password (card's code number), it is possible to confirm that an operator operating the portable information terminal device 20 is the owner (person) of the IC card 10. If this personal confirmation is not obtained, the terminal CPU 21 does not proceed to processing after this.

If the personal confirmation is obtained, the terminal CPU 21 proceeds to information reading processing (step S2). That is, the terminal CPU 21 activates the information reading sensor 25 to make the information reading sensor 25 read the information stored in the chip memory 112 of the IC card 10 and stores the read information to the terminal memory 22 as the stored information.

After the terminal CPU 21 stores the information in the terminal memory 22, the terminal CPU 21 carries out retrieval processing (step S3). At first, the terminal CPU 21 displays the message on the display portion 24 to show that the preparation for the retrieval processing is completed and requests the operator to operate the keyboard 23 to proceed with the retrieval processing. In order to obtain the desired information, the operator operates the keyboard 23 to issue a retrieval command to the terminal CPU 21. Responsive to the retrieval command, the terminal CPU 21 retrieves the information stored in the terminal memory 22 to obtain the desired retrieved information.

When the desired retrieved information is obtained, the terminal CPU 21 displays the retrieved information on the display screen of the display portion 24 (step S4).

As described above, the owner of the IC card 10 can easily confirm the desired information by retrieving the information stored in the own IC card 10.

Now, description will proceed to examples of the information retrieval among various types of the information retrieval. In the example being illustrated, it will be assumed that screens of “retrieval for enterprise's names” and “retrieval for types (categories) of industry” are pre-set on the display screen of the display portion 23. Description will first be made as regards the “retrieval for enterprise's names” and will subsequently be made as regards the “retrieval for types (categories) of industry.”

(1) Retrieval for enterprise's names

The retrieval for enterprise's names can be carried out by designating the initials of the enterprise's names inputted to the keyboard 23 by the operator. For example, it will be assumed that the operator wants to retrieve, as a particular enterprise's name, “Sumitomo Mitsui Banking Corporation.” In this event, the operator designates (inputs) “S” by operating the keyboard 23.

More specifically, the operator at first inputs a retrieval command for enterprise's names designating “retrieval for enterprise's names.” Responsive to the retrieval command for enterprise's names, the terminal CPU 21 makes the display screen of the display portion 24 to be able to input an initials of the enterprise's name. On the screen, the operator designates the initial of a target enterprise's name from the keyboard 23. That is, in the example being illustrated, the operator inputs “S” by operating the keyboard 23. Responsive to this designation, the terminal CPU 21 retrieves the terminal memory 22 to obtain the enterprise's names having the initials “S” and makes the display screen of the display portion 24 a screen indicative of a list of the enterprise's names having the initials “S.” The operator designates the target enterprise's name among the list on the screen to display registered information on the display screen of the display portion 24.

(2) Retrieval for types (categories) of industry

The retrieval is carried out in a case of displaying a list of types of industry (a credit card, a house card, a commutation ticket, banks, or the like).

More specifically, the operator at first inputs, by operating the keyboards 23, a retrieval command for types (categories) of industry designating “retrieval for types (categories) of industry.” Responsive to the retrieval command for types (categories) of industry, the terminal CPU 21 makes the display screen of the display portion 24 a screen enable to input a type (category) of industry. On this screen, the operator designates a target type of industry from the keyboard 23. Responsive to this designation, the terminal CPU 21 retrieves the terminal memory 22 to obtain enterprise's names belonging to the target type of industry and makes the display screen of the display portion 24 a screen indicative of a list of the enterprise's names belonging to the target type of industry. The operator designates a target enterprise's name among the list on the screen to display registered information on the display screen of the display portion 24.

(3) Displaying of a list of enterprise's names

In a case of displaying a list of enterprise's names, the following operation may be carried out.

The operator inputs, by operating the keyboard 23, a displaying command for a list of enterprise's names designating “displaying of a list of enterprise's names.” Responsive to the displaying command for the list of enterprise's names, the terminal CPU 21 retrieves the terminal memory 22 to display the list of enterprise's names on the display screen of the display portion 24.

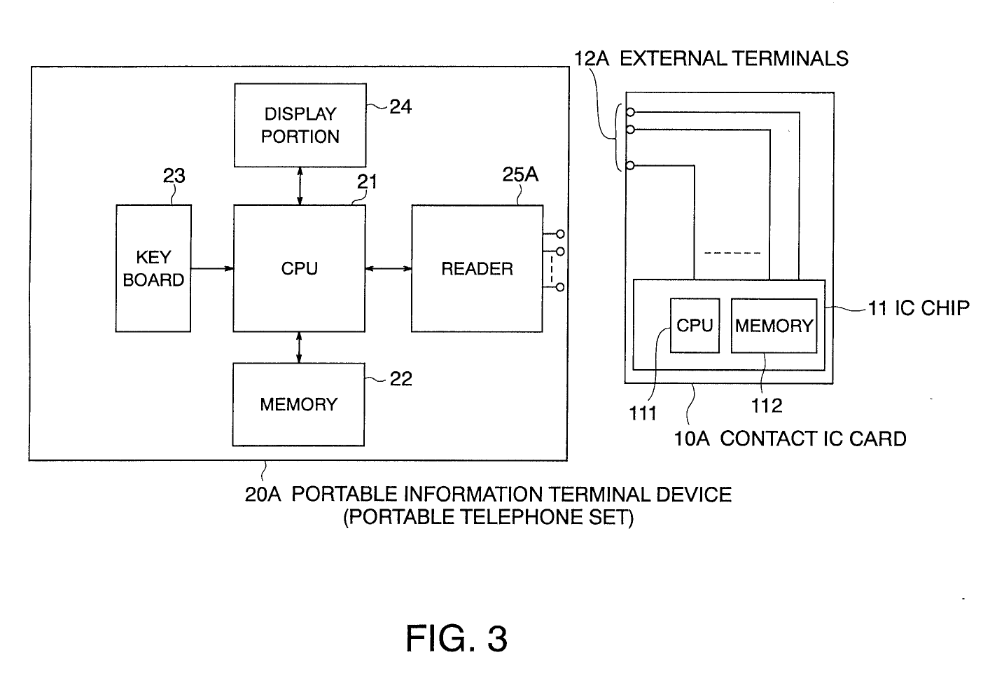

Referring to FIG. 3, the description will proceed to a portable information terminal device 20A which realizes an information retrieval method for an IC card 10A according to a second embodiment of this invention.

The illustrated IC card 10A is a contact IC card. That is, the IC card 10A is similar in structure and operation to the IC card 10 illustrated in FIG. 1 except that the IC card 10A comprises external terminals 12A instead of the antenna coil 12.

The illustrated portable information terminal device 20A is similar in structure and operation to the portable information terminal device 20 illustrated in FIG. 1 except that the portable information terminal device 20A comprises a reader 25A in place of the information reading sensor 25. The reader 25A is embedded in the portable information terminal device 25A. When the external terminals 12A of the IC card 10A are connected to the reader 25A, the reader 25A reads information stored in the chip memory 112 through the external terminals 12A to store read information to the terminal memory 22 via the terminal CPU 21 as stored information.

While this invention has been described in conjunction with a few embodiments thereof, it will readily be possible for those skilled in the art to put this invention into practice in various other manners. For example, although description is made by exemplifying a case where the portable information terminal device is the portable telephone set in the above-mentioned embodiments, the portable information terminal device may be one of other portable information terminal devices such as a personal handy-phone system (PHS). In addition, an input arrangement may not be restricted to the keyboard.

What is claimed is:

1. A method of retrieving information stored in an integrated circuit (IC) card, said method comprising the steps of:
reading the information in said IC card using an information reading sensor mounted in a portable information terminal device comprising input means, display means, and memory means to store read information in said memory means as stored information;
retrieving, in response to operation of said input means of said portable information terminal device, said stored information in said memory means to obtain only desired information as retrieved information; and
displaying said retrieved information on said display means of said portable information terminal device.

2. A method as claimed in claim 1, wherein said information reading sensor is embedded in said portable information terminal device.

3. A method as claimed in claim 1, wherein said IC card is a non-contact IC card for mounting an IC chip for recording directory information indicative of a list of said information stored in said IC card, said directory information being read by holding said non-contact IC card to said information reading sensor on reading to display said directory information on said display means.

4. A method as claimed in claim 1, wherein said portable information terminal device comprises a portable telephone set.

5. A method as claimed in claim 1, wherein said portable information terminal device comprises a personal handy-phone system (PHS) phone.

6. A method of retrieving information stored in an integrated circuit (IC) card, said method comprising the steps of:
reading the information in said IC card using a reader mounted in a portable information terminal device comprising input means, display means, and memory means to store read information in said memory means as stored information;
retrieving, in response to operation of said input means of said portable information terminal device, said stored information in said memory means to obtain only desired information as retrieved information; and
displaying said retrieved information on said display means of said portable information terminal device.

7. A method as claimed in claim 6, wherein said reader is embedded in said portable information terminal device.

8. A method as claimed in claim 6, wherein said IC card is a contact IC card for mounting an IC chip for recording directory information indicative of a list of said information stored in said IC card, said directory information being read by connecting external terminals of said contact IC card to said reader on reading to display said directory information on said display means.

9. A method as claimed in claim 6, wherein said portable information terminal device comprises a portable telephone set.

10. A method as claimed in claim 6, wherein said portable information terminal device comprises a personal handy-phone system (PHS) phone.

11. A portable information terminal device comprising input means, display means, and memory means, wherein the improvement comprises:
an information reading sensor for reading information stored in an integrated circuit (IC) card to store read information in said memory means as stored information;
means, in response to operation of said input means, retrieving said stored information in said memory means to obtain only desired information as retrieved information; and
means for displaying said retrieved information on said display means.

12. A portable information terminal device as claimed in claim 11, wherein said information reading sensor is embedded in said portable information terminal.

13. A portable information terminal device as claimed in claim 11, wherein said IC card is a non-contact IC card for mounting an IC chip for recording directory information indicative of a list of said information stored in said IC card, said portable information terminal device reading said directory information by holding said non-contact IC card to said information reading sensor on reading to display said directory information on said display means.

14. A portable information terminal device as claimed in claim 11, wherein said portable information terminal device comprises a portable telephone set.

15. A portable information terminal device as claimed in claim 11, wherein said portable information terminal device comprises a personal handy-phone system (PHS) phone.

16. A portable information terminal device comprising input means, display means, and memory means, wherein the improvement comprises:
a reader for reading information stored in an integrated circuit (IC) card to store read information in said memory means as stored information;
means, in response to operation of said input means, retrieving said stored information in said memory means to obtain only desired information as retrieved information; and
means for displaying said retrieved information on said display means.

17. A portable information terminal device as claimed in claim 16, wherein said reader is embedded in said portable information terminal.

18. A portable information terminal device as claimed in claim 16, wherein said IC card is a contact IC card for mounting an IC chip for recording directory information indicative of a list of said information stored in said IC card, said portable information terminal device reading said directory information by connecting external terminals of said contact IC card to said reader on reading to display said directory information on said display means.

19. A portable information terminal device as claimed in claim 16, wherein said portable information terminal device comprises a portable telephone set.

20. A portable information terminal device as claimed in claim 16, wherein said portable information terminal device comprises a personal handy-phone system (PHS) phone.
